(19) United States
(12) Patent Application Publication
(10) Pub. No.: US 2016/0217052 A1
(43) Pub. Date: Jul. 28, 2016

(54) DEBUG CIRCUIT, DEBUG REQUEST CIRCUIT AND DEBUG SYSTEM

(71) Applicants: AMBIT MICROSYSTEMS (SHANGHAI) LTD., Shanghai (CN); HON HAI PRECISION INDUSTRY CO., LTD., New Taipei (TW)

(72) Inventors: YANG-CHIH LIN, New Taipei (TW); YU-HU YAN, New Taipei (TW)

(21) Appl. No.: 15/001,269

(22) Filed: Jan. 20, 2016

(30) Foreign Application Priority Data
Jan. 26, 2015 (TW) 104102438

(51) Int. Cl. G06F 11/22; G06F 13/42

(52) U.S. Cl. CPC G06F 11/221; G06F 13/4282

(57) ABSTRACT

A debug circuit set in a host device includes a first USB interface, a USB communication unit, a UART communication unit, a detection unit and a switch unit. The USB communication unit is configured to communicate with other devices. The UART communication unit is configured to obtain debug information of the host device. The detection unit is configured to output a detection signal. The debug circuit communicates with other devices through the first USB interface when the switch unit connects the USB communication unit with the first USB interface. The debug circuit outputs the debug information through the first USB interface when the switch unit connects the UART communication unit with the first USB interface.

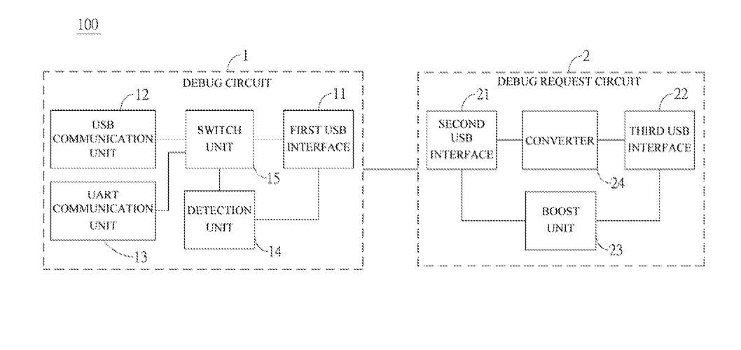

### FIELD

The subject matter herein generally relates to debug circuits.

### BACKGROUND

If an error occurs in an operation process of a device, developers generally get error information through a Universal Asynchronous Receiver/Transmitter (UART) interface for debugging. System source code can be read from the UART interface. In order to protect system source code from being read illegally, the UART interface is hidden in a housing of the device. When developers need debugging, developers have to open or destroy the housing to connect the UART interface.

### SUMMARY

In one aspect of the disclosure, a debug circuit includes a first Universal Serial Bus interface, a first Universal Serial Bus interface, a Universal Serial Bus communication unit, a Universal Asynchronous Receiver/Transmitter communication unit and a detection unit and a switch unit.

The Universal Serial Bus communication unit is configured to communicate with other devices. The Universal Asynchronous Receiver/Transmitter communication unit is configured to obtain debug information of the host device. The detection unit coupled to the first Universal Serial Bus interface is configured to detect and judge whether the first Universal Serial Bus interface receiving a debug request signal and output a detection signal. The switch unit coupled to the first Universal Serial Bus interface, the detection unit, the Universal Serial Bus communication unit and the Universal Asynchronous Receiver/Transmitter communication unit, is configured to connect the Universal Serial Bus communication unit with the first Universal Serial Bus interface or connect the Universal Asynchronous Receiver/Transmitter communication unit with the first Universal Serial Bus interface according to the detection signal.

The first Universal Serial Bus interface communicates with the other devices when the switch unit connects the Universal Serial Bus communication unit with the first Universal Serial Bus interface. The first Universal Serial Bus interface outputs the debug information when the switch unit connects the Universal Asynchronous Receiver/Transmitter communication unit with the first Universal Serial Bus interface.

### BRIEF DESCRIPTION OF THE DRAWING

Implementations of the present technology will now be described, by way of example only, with reference to the attached FIGURE.

The FIGURE is a diagrammatic view of one embodiment of a debug circuit, a debug request circuit and a debug system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a debug circuit, a debug request circuit and a debug system.

Referring to the FIGURE, in at least one embodiment, the debug system 100 includes a debug circuit 1 and a debug request circuit 2. The debug circuit 1 can be set in a host device. The debug circuit 1 is configured to obtain and output debug information during starting or operating the host device.

The debug request circuit 2 is configured to generate and output a debug request signal. When the debug circuit 1 receives the debug request signal from the debug request circuit 2, the debug circuit 1 outputs the debug information to some analytical instruments through the debug request circuit 2, thus developers can debug programming error.

In the embodiment, the debug request circuit 2 is set in the host device. In at least one embodiment, the host device can be one of computers, switches and servers. The debug request circuit 2 can be designed to be an individual device. And the individual device can connect with the host device to communicate with the host device.

The debug circuit 1 includes a first Universal Serial Bus (USB) interface 11, a Universal Serial Bus (USB) communication unit 12, a Universal Asynchronous Receiver/Transmitter (UART) communication unit 13, a detection unit 14 and a switch unit 15.

The USB communication unit 12 is configured to communicate with other devices. The UART communication unit 13 is configured to obtain debug information of the host device. The detection unit 14 is coupled to the first USB interface 11. The detection unit 14 is configured to detect and judge whether the first USB interface 11 receiving a debug request signal. The detection unit 14 then correspondingly outputs a detection signal.

In at least one embodiment, the detection unit judges whether receiving a debug request signal by detecting a voltage of a power pin in the first Universal Serial Bus interface.

In at least one embodiment, when the detection unit 14 judges that the first USB interface 11 has received the debug request signal, the detection unit 14 outputs a high level voltage signal. When the detection unit 14 judges that the first USB interface 11 has not received the debug request signal, the detection unit 14 outputs a low level voltage signal.

The switch unit 15 is coupled to the first USB interface 11, the USB communication unit 12, the UART communication unit 13 and the detection unit 14. According to the detection signal, the switch unit 15 is configured to connect the USB communication unit 12 with the first USB interface 11 or connect the UART communication unit 13 with the first USB interface 11.

In at least one embodiment, the host device communicates with other devices through the first USB interface 11 when the switch unit 15 connects the USB communication unit 12 with the first USB interface 11. The host device outputs the debug information through the first USB interface 11 when the switch unit 15 connects the UART communication unit 13 with the first USB interface 11.

When the detection unit 14 judges that the first USB interface 11 has received the debug request signal, the detection unit 14 outputs a detection signal of a high level voltage. Then the switch unit 15 connects the UART communication unit 13 with the first USB interface 11. Thus the debug information of the host device obtained by the UART communication unit 13 can be transmitted to the debug request circuit 2 through the first USB interface 11.

Otherwise, when the detection unit 14 judges that the first USB interface 11 has not received the debug request signal, the detection unit 14 outputs a detection signal of a low level voltage. Then the switch unit 15 connects the USB communication unit 12 with the first USB interface 11. Thus the USB communication unit 12 can communicate with other devices as a normal USB. In this condition, the first USB interface 11 used as a normal USB interface for the host device communicating with other devices.

In at least one embodiment, the first USB interface 11 can be a USB female connector. The detection unit 14 can be a voltage detector. The switch unit 15 is a single pole double throw (SPDT) switch. When developers need debugging, developers have not to open or destroy the housing to connect the UART interface. In the embodiment, developers just need connect analytical instruments with the first USB interface 11, and they will get the debug information.

The debug request circuit 2 includes a second USB interface 21, a third USB interface 22, a boost unit 23 and a converter 24.

The second USB interface 21 receives the debug information when the second USB interface 21 is coupled to the first USB interface 11. The third USB interface 22 is configured to couple to some analytical instruments, such as computers with analysis software. The boost unit 23 is coupled between the second USB interface 21 and the third USB interface 22. The boost unit 23 is configured to generate the debug request signal by increasing an input voltage of the third USB interface 22. Then the second USB interface 21 outputs the debug request signal.

The debug circuit 1 receives the debug request signal through the first USB interface 11. Then the UART communication unit 13 outputs the debug information to the second USB interface 21 through the first USB interface 11.

In at least one embodiment, the debug circuit 1 obtains the debug information of the host device through the UART communication unit 13. Therefore, the debug information is a UART format. The converter 24 is coupled between the second USB interface 21 and the third USB interface 22. The converter 24 is configured to convert the debug information into debug information of a USB format. Then the debug information of a USB format is transmitted to the analytical instruments through the third USB interface 22.

When the debug system 100 is debugging an error, the first end of the debug request circuit 2 is coupled to the debug circuit 1 through the second USB interface 21 and the first USB interface 11. The second end of the debug request circuit 2 is coupled to the analytical instruments through the third USB interface 22.

In at least one embodiment, a power pin of the third USB interface 22 has an input voltage of 5 voltages. The boost unit 23 increases the voltage to a preset value. Then the second USB interface 21 outputs the increased voltage to a power pin in the first USB interface 11. The preset value can be 8 voltages. As a result, the detection unit 14 detects the power pin in the first USB interface 11 changing from 5 voltages to 8 voltages. Then the detection unit 14 judges that the debug circuit 1 has received the debug request signal.

In at least one embodiment, when the debug system 100 is debugging an error, the debug request circuit 2 is further configured to receive a stop debugging signal from the analytical instruments through the third USB interface 22. The converter 24 is further configured to convert the stop debugging signal into a stop debugging signal of a UART format. Then the stop debugging signal of a UART format is transmitted to the UART communication unit 13. When the UART communication unit 13 receives the stop debugging signal of a UART format, the UART communication unit 13 stop outputting the debug information.

Many details are often found in art including other features of the debug circuit, the debug request circuit and the debug system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A debug circuit set in a host device, comprising:
a first Universal Serial Bus interface;
a Universal Serial Bus communication unit configured to communicate with other devices ;
a Universal Asynchronous Receiver/Transmitter communication unit configured to obtain debug information of the host device;
a detection unit coupled to the first Universal Serial Bus interface, configured to detect and judge whether the first Universal Serial Bus interface receiving a debug request signal and output a detection signal; and
a switch unit coupled to the first Universal Serial Bus interface, the detection unit, the Universal Serial Bus communication unit and the Universal Asynchronous Receiver/Transmitter communication unit, configured to connect the Universal Serial Bus communication unit with the first Universal Serial Bus interface or connect the Universal Asynchronous Receiver/Transmitter communication unit with the first Universal Serial Bus interface according to the detection signal;
wherein, the first Universal Serial Bus interface communicates with the other devices when the switch unit connects the Universal Serial Bus communication unit with the first Universal Serial Bus interface, and outputs the debug information when the switch unit connects the Universal Asynchronous Receiver/Transmitter communication unit with the first Universal Serial Bus interface.

2. The debug circuit as claimed in claim 1, wherein the detection unit is further configured to judge whether receiving a debug request signal by detecting a voltage of a power pin in the first Universal Serial Bus interface.

3. The debug circuit as claimed in claim 1, wherein the debug circuit stops outputting the debug information when the Universal Asynchronous Receiver/Transmitter communication unit receives a stop debugging signal.

4. A debug request circuit comprising:
a second Universal Serial Bus interface configured to receive debug information;
a third Universal Serial Bus interface configured to communicate with the second Universal Serial Bus interface; and
a converter coupled between the second Universal Serial Bus interface and the third Universal Serial Bus interface, configured to convert the debug information into debug information of a Universal Serial Bus format, and output the debug information of a Universal Serial Bus format to the third Universal Serial Bus interface.

5. The debug request circuit as claimed in claim 4, wherein the debug request circuit further comprises a boost unit coupled between the second Universal Serial Bus interface and the third Universal Serial Bus interface, and the boost unit is configured to generate a debug request signal by increasing an input voltage of the third Universal Serial Bus interface.

6. The debug request circuit as claimed in claim 4, wherein the third Universal Serial Bus interface is further configured to receive a stop debugging signal, and the converter is further configured to convert the stop debugging signal into a stop debugging signal of a Universal Asynchronous Receiver/Transmitter format, and output the stop debugging signal of a Universal Asynchronous Receiver/Transmitter format to the second Universal Serial Bus interface.

7. A debug system comprising:
a debug circuit; and
a debug request circuit;
wherein the debug circuit set in a host device comprises:
a first Universal Serial Bus interface;
a Universal Serial Bus communication unit configured to communicate with other devices;
a Universal Asynchronous Receiver/Transmitter communication unit configured to obtain debug information of the host device;
a detection unit coupled to the first Universal Serial Bus interface, configured to judge whether receiving a debug request signal, and output a detection signal; and
a switch unit coupled to the first Universal Serial Bus interface, the detection unit, the Universal Serial Bus communication unit and the Universal Asynchronous Receiver/Transmitter communication unit, configured to connect the Universal Serial Bus communication unit with the first Universal Serial Bus interface or connect the Universal Asynchronous Receiver/Transmitter communication unit with the first Universal Serial Bus interface according to the detection signal;
wherein the debug request circuit comprises:
a second Universal Serial Bus interface configured to output the debug request signal and receive the debug information;
wherein, the second Universal Serial Bus interface outputs the debug request signal to the detection unit through the first Universal Serial Bus interface, then the Universal Asynchronous Receiver/Transmitter communication unit connects with the first Universal Serial Bus interface and output the debug information to the second Universal Serial Bus interface through the first Universal Serial Bus interface.

8. The debug system as claimed in claim 7, wherein the detection unit is further configured to judge whether receiving the debug request signal by detecting a voltage of a power pin in the first Universal Serial Bus interface.

9. The debug system as claimed in claim 7, wherein the debug request circuit further comprises:
a third Universal Serial Bus interface configured to communicate with the second Universal Serial Bus interface; and
a converter coupled between the second Universal Serial Bus interface and the third Universal Serial Bus interface, configured to convert the debug information into debug information of a Universal Serial Bus format, and output the debug information of a Universal Serial Bus format to the third Universal Serial Bus interface.

10. The debug system as claimed in claim 9, the debug request circuit further comprising a boost unit coupled between the second Universal Serial Bus interface and the third Universal Serial Bus interface, wherein the boost unit is configured to generate a debug request signal by increasing an input voltage of the third Universal Serial Bus interface.

11. The debug system as claimed in claim 9, wherein the third Universal Serial Bus interface is further configured to receive a stop debugging signal, and the converter is further configured to convert the stop debugging signal into a stop debugging signal of a Universal Asynchronous Receiver/Transmitter format, and output the stop debugging signal of a Universal Asynchronous Receiver/Transmitter format to the second Universal Serial Bus interface.

12. The debug system as claimed in claim 11, wherein the stop debugging signal of a Universal Asynchronous Receiver/Transmitter format transmits from the second Universal Serial Bus interface to the first Universal Serial Bus interface, when the Universal Asynchronous Receiver/Transmitter communication unit connects to the first Universal Serial Bus interface and receives the stop debugging signal of a Universal Asynchronous Receiver/Transmitter format, the debug circuit stops outputting the debug information.
